(19) United States
(12) Patent Application Publication
(10) Pub. No.: US 2008/0069977 A1
(43) Pub. Date: Mar. 20, 2008

(54) Trophy mount and method

(76) Inventor: Charles T. McAbee, Hartselle, AL (US)

Correspondence Address: BRADLEY ARANT ROSE & WHITE LLP, 200 CLINTON AVE. WEST, SUITE 900, HUNTSVILLE, AL, 35801, US

(21) Appl. No.: 11/524,366

(22) Filed: Sep. 20, 2006

(51) Int. Cl. A01N 1/00

(52) U.S. Cl. 428/16

(57) ABSTRACT

A trophy mount and a method of making a trophy mount are provided. A skull plate containing antlers or horns may be placed within a mold wherein plaster, concrete, clay, or an epoxy may be poured over the base of the antlers or horns. After the plaster, concrete, clay, or epoxy hardens, the mold is removed to reveal a base within which the antlers or horns are mounted. The mold may shaped to provide a base which resembles any variety of different shapes, items, characters, or novelty items.

### FIELD OF THE INVENTION

The present disclosure relates generally to a mount for exhibiting animal horns and antlers. In particular, the present disclosure is directed toward a method and apparatus for incorporating animal horns or antlers on a formable base for either a wall or tabletop display.

### BACKGROUND OF THE INVENTION

Many ruminant animals have horns or antlers which are displayed as a trophy as evidence of a successful hunt (throughout this disclosure, “horn” and “antler” may be used interchangeably). Commonly, the head and a portion of the neck are taken to a taxidermist who prepares the trophy for mounting on a wall. Such trophies, however, can be large, heavy and cumbersome. Furthermore, such mountings can be very expensive. To address these problems, the prior art teaches the display of horns, antlers and like objects in many different manners. For example, in U.S. Pat. No. 453,008, a plate or escutcheon is disclosed and used for suspending animal horns from a wall. U.S. Pat. No. 2,003,896 discloses a horn wall mount. U.S. Pat. No. 4,981,865 discloses an adjustable antler hanger bracket. In U.S. Pat. No. 4,464,440, a trophy mount is described having a simulated skull structure for mounting and displaying horns and antlers. Furthermore, in U.S. Pat. No. 5,472,765, a shed antler mounting kit is disclosed.

These methods and devices can be expensive and mainly relegate the display of such trophies to walls. The present disclosure effectively addresses these problems and is directed toward a method and apparatus for incorporating antlers, horns, or the like into a base portion which may be either be mounted to a wall or set on a table, display case, mantle, or other flat surface.

### SUMMARY OF THE INVENTION

The present disclosure is directed to a method and apparatus for displaying animal horns or antlers. This is accomplished by incorporating such horns or antlers into a base or pedestal. The horns or antlers can remain attached to the skull plate, or each can be mounted separately. If mounted separately, the horns or antlers can be mechanically coupled together at their respective bases to maintain symmetry during the incorporation process. The base is made from a mold which can be shaped to suit the tastes and preferences of the user. The mold can be used to form common three-dimensional geometric shapes such as a square, rectangle, pyramid, hemisphere, or cylinder. It can also be made to look like naturally occurring objects such as a tree stump, rock, or skull. Furthermore, the mold can be used to form novelty shapes such as real life or fictional characters, college logos and mascots, or other unique shapes.

The horns or antlers are incorporated into a base using a transformable substance such as plaster, clay, concrete, epoxy, or other substance in a paste, liquid, or semi-solid form that hardens either with or without the addition of heat or other curing substances. The transformable substance is poured over the base of the horns or antlers after they have been positioned in the desired location within the mold. After the transformable substance has hardened and the mold has been removed, a plate can be attached to the mount to identify the hunter, year, species, or provide any other information pertinent to the trophy.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

These and other embodiments of the present disclosure will also become readily apparent to those skilled in the art from the following detailed description of the embodiments having reference to the attached figures, the invention not being limited to any particular embodiment(s) disclosed.

### BRIEF DESCRIPTION OF THE DRAWINGS

The present disclosure is described with reference to the accompanying drawings. In the drawings, like reference numbers indicate identical or functionally similar elements. Additionally, the left-most digit(s) of a reference number identifies the drawing in which the reference number first appears.

FIG. 1 is a perspective view of a trophy mount mold;

FIG. 2 is a perspective view of a trophy mount mold with antlers suspended above the mold;

FIG. 3 is a perspective view of a trophy mount mold showing plaster being poured over the skull plate of the antlers into the mold;

FIG. 4 is perspective view of a trophy mount mold showing antlers set in plaster;

FIG. 5 is a perspective view of a trophy mount after the mold has been removed and a plate has been attached identifying the trophy.

### DETAILED DESCRIPTION

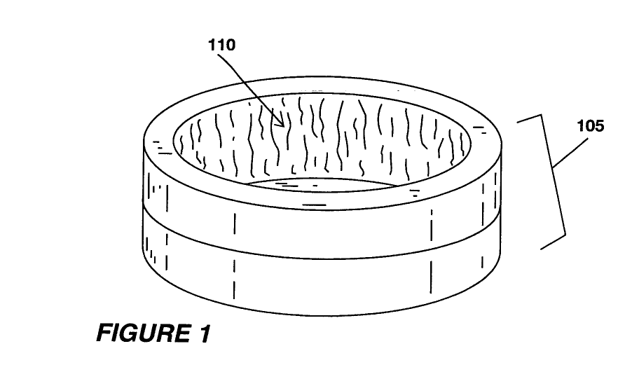

The various embodiments of the present invention and their advantages are best understood by referring to FIGS. 1 through 5 of the drawings. The elements of the drawings are not necessarily to scale, emphasis instead being placed upon clearly illustrating the principles of the invention. Throughout the drawings, like numerals are used for like and corresponding parts of the various drawings.

Referring now to FIG. 1, a mold 105 is provided wherein the interior wall 110 is contoured to resemble part of a tree trunk. The mold 105 can be made of metal, wood, plastic, rubber epoxy and should be of sufficient density to contain a transformable substance such as plaster, concrete, clay, epoxy, or some other substance in a paste, liquid, or semi-solid form that hardens with or without the addition of heat or additional curing substances. The mold 105 can take any shape to suit the tastes and preferences of the trophy holder. For example, the mold 105 can be used to make common three-dimensional geometric shapes such as a square, rectangle, pyramid, hemisphere, or cylinder. The mold 105 can also be used to form novelty shapes. Furthermore, the mold should be of sufficient size to receive the horn or antler to be incorporated into the trophy mount.

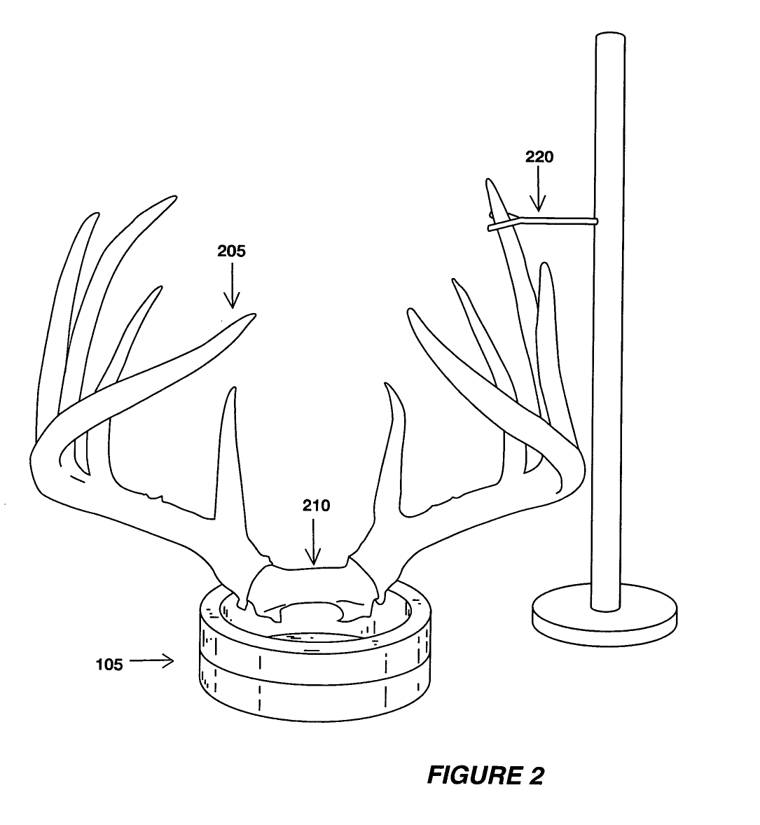

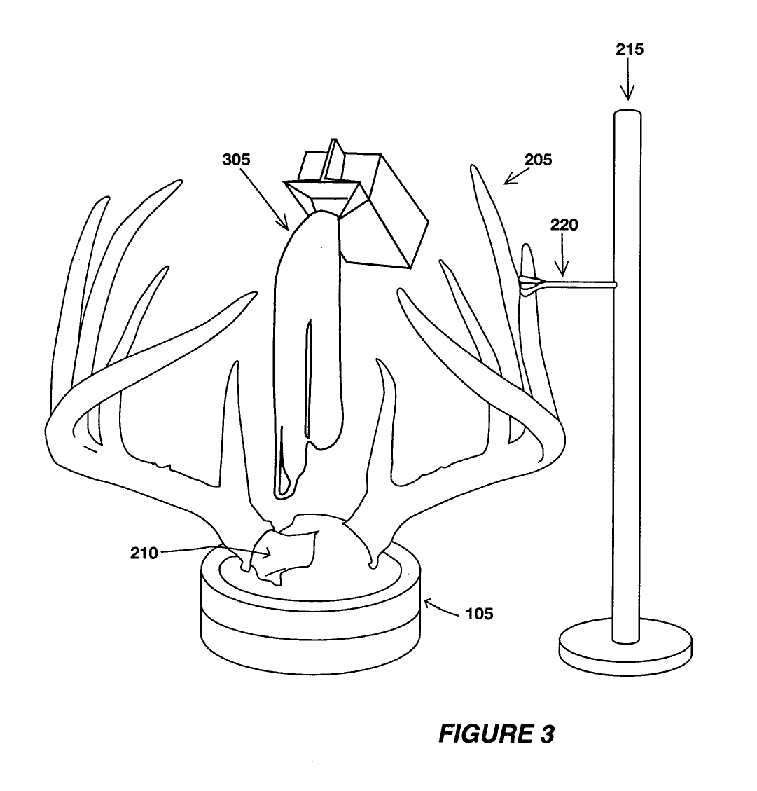

As shown on FIG. 2, the antlers 205 from a deer remain attached to the skull plate 210, and together are suspended above the mold 105 using a stand 215 and clamp 220. In an alternative embodiment, the antlers may be positioned separately and suspended above or within the mold in locations determined by the tastes and preferences of the recipient of the trophy. Referring now to FIG. 3, when the antlers 205 and skull plate 210 are in position over the mold 105, plaster 305 is poured over the skull plate 210. In one embodiment, Tuffstone gypsum is used. In lieu of plaster, epoxy, concrete, clay, or some other transformable substance in paste, liquid, or semi-solid form can be used (for purposes of this disclosure, any reference to plaster can include the other substances as well). Such transformable substance should possess the characteristic of being able to harden over time with or without the addition of heat or additional curing substances.

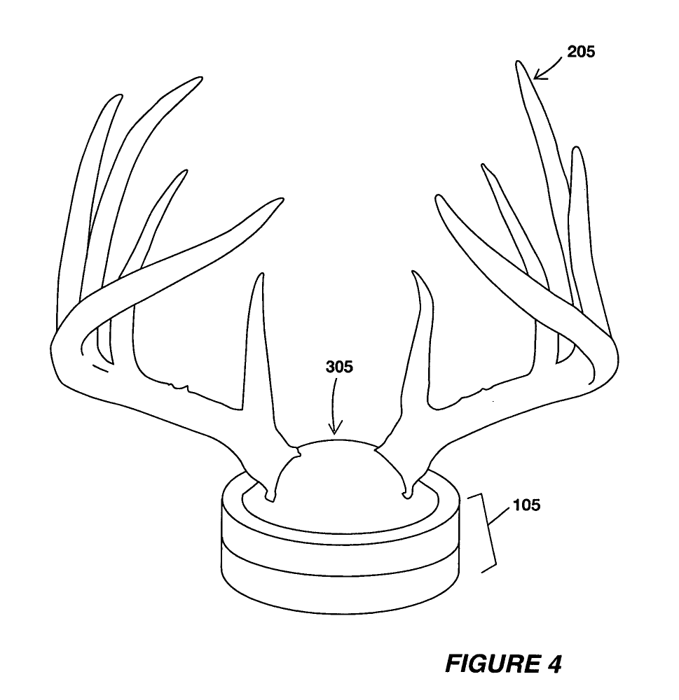

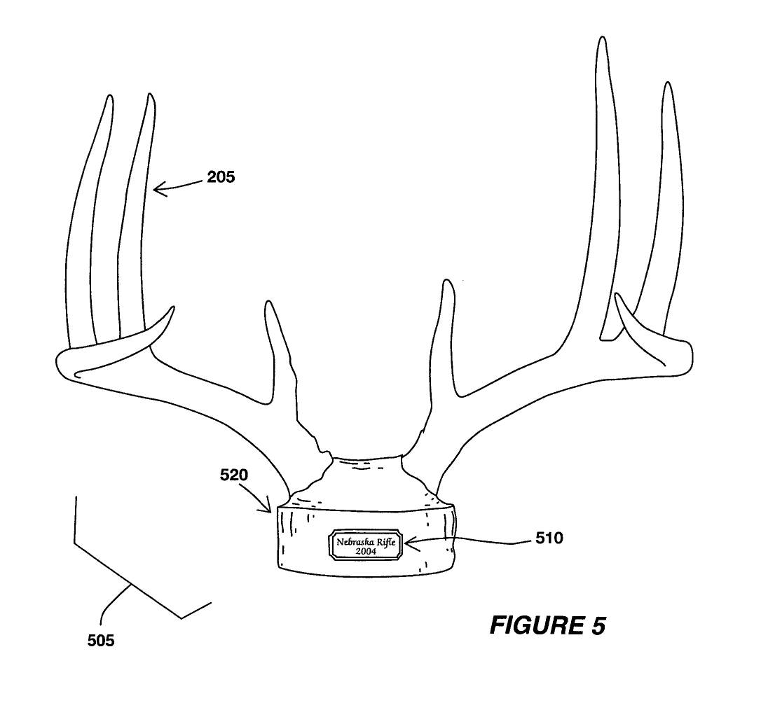

FIG. 4 shows the mold 105, antlers 205, and plaster 305, after the plaster 305 has been poured. FIG. 5 shows the trophy mount 505 after the plaster has hardened and the mold has been removed, revealing antlers 205 emerging out of a tree trunk-shaped base 520. The exterior surface of the base embodies the contours of the mold and resembles a tree trunk. If another shape is desired, a different mold could be used.

When plaster is poured into the mold, it will fill in the negative space resulting in the shape of the mold. The mold can be used to form common three-dimensional geometric shapes such as a square, rectangle, pyramid, hemisphere, or cylinder. It can also be made to look like naturally occurring objects such as a tree trunk, rock, or skull. Furthermore, the mold can be used to form novelty shapes such as real life or fictional characters, college logos and mascots, or other unique shapes. The plaster can be painted, stained, or otherwise colored to add realism to the design. Furthermore, a plate or tag 510 can be attached to the trophy mount and identify the characteristics of the trophy.

Other items, such as clocks, pen holders, or business card holders, can be incorporated into the base. Furthermore, the trophy mount can be modified to include a light socket and lamp shade.

This invention may be provided in other specific forms and embodiments without departing from the essential characteristics as described herein. The embodiments described above are to be considered in all aspects as illustrative only and not restrictive in any manner. The following claims rather than the foregoing description indicate the scope of the invention.

As described above and shown in the associated drawings, the present disclosure comprises a horn or antler mount and method. While particular embodiments of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements that embody the spirit and scope of the present invention.

What is claimed is:

1. A trophy mount comprising:
a. a base; and
b. antlers incorporated into said base;
wherein said base sets on a flat surface and said antlers project away therefrom.

2. The trophy mount of claim 1 wherein said base's shape is selected from the group comprising: a tree trunk, rock, skull, square, rectangle, pyramid, hemisphere, or cylinder.

3. The trophy mount of claim 1 wherein said antlers are connected together by a skull plate, and said skull plate is incorporated into said base.

4. The trophy mount of claim 1 wherein said antlers are mechanically coupled together at said antlers' respective bases, and said mechanical coupling device is incorporated into said base.

5. The trophy mount of claim 1 further comprising a plate attached to said base upon which said antlers may be identified.

6. The trophy mount of claim 1 further comprising a clock attached to said base.

7. The trophy mount of claim 1 wherein said base is comprised of one of the group comprising plaster, concrete, clay, or epoxy.

8. The trophy mount of claim 1 wherein said base is comprised of a paste that hardens with the addition of heat.

9. The trophy mount of claim 1 wherein said base is comprised of a paste that hardens with the addition of a curing substance.

10. The trophy mount of claim 1 further comprising a light bulb socket, a lamp shade, and electrical wiring wherein said mount can be used as a lamp.

11. A method of making a trophy mount comprising:
a. setting antlers immediately above or directly within a substantially hollow mold;
b. delivering a transformable substance into said mold such that the respective bases of said antlers are covered by said transformable substance;
c. allowing said transformable substance to harden;
d. removing said mold from around said transformable substance.

12. The method of claim 11 wherein said transformable substance is selected from one of the group comprising plaster, concrete, clay, or epoxy.

13. The method of claim 11 wherein said transformable substance is comprised of a paste that hardens with the addition of heat.

14. The method of claim 11 wherein said transformable substance is comprised of a paste that hardens with the addition of a curing substance.

15. The method of claim 11 further comprising the step of adding a plate to said transformable substance.

16. The method of claim 11 wherein said mold's interior surface is shaped to resemble one of the group comprising: a tree trunk, rock, skull, square, rectangle, pyramid, hemisphere, or cylinder.

17. The method of claim 11 further comprising the step of painting said transformable substance to resemble one of the group comprising: a tree trunk, rock, skull, square, rectangle, pyramid, hemisphere, or cylinder.

18. The method of claim 11 further comprising the steps of adding a light bulb socket and lamp shade, and wiring said trophy mount wherein said trophy mount may be used as a lamp.

19. A trophy mount made from the process of:
a. setting antlers immediately above or directly within a substantially hollow mold;
b. delivering a transformable substance into said mold such that the respective bases of said antlers are covered by said transformable substance;
c. allowing said transformable substance to harden;
d. removing said mold from around said transformable substance.

20. The trophy of claim 19 wherein said transformable substance is selected from the group comprising plaster, concrete, clay, or epoxy.

21. The trophy of claim 19 wherein said transformable substance is comprised of a paste that hardens with the addition of heat.

22. The trophy of claim 19 wherein said transformable substance is comprised of a paste that hardens with the addition of a curing substance.

23. The trophy of claim 19 further comprising the step of adding a plate to said transformable substance.

24. The trophy of claim 19 wherein said mold's interior surface is shaped to resemble one of the group comprising: a tree trunk, rock, skull, square, rectangle, pyramid, hemisphere, or cylinder.

25. The trophy of claim 19 further comprising the step of painting said plaster to resemble one of the group comprising: a tree trunk, rock, skull, square, rectangle, pyramid, hemisphere, or cylinder.

26. The trophy mount of claim 19 further comprising the steps of adding a light bulb socket and lamp shade, and wiring said trophy mount wherein said trophy mount may be used as a lamp.
